(19) United States
(12) Patent Application Publication
(10) Pub. No.: US 2005/0080533 A1
(43) Pub. Date: Apr. 14, 2005

(54) Vehicle passenger seat sensor network

(76) Inventors: Otman A. Basir, Waterloo (CA); David Bullock, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 10/953,889

(22) Filed: Sep. 29, 2004

Related U.S. Application Data
(60) Provisional application No. 60/506,944, filed on Sep. 29, 2003.

(51) Int. Cl. G06F 17/00

(52) U.S. Cl. 701/45; 180/273

(57) ABSTRACT

A vehicle passenger seat sensor network includes a plurality of vehicle seats, each having a plurality of occupant sensors associated therewith. A seat processor on each seat performs some analysis and processing of the data from the plurality of sensors and sends information based upon the data over a network to a central processor. The central processor receives the information from each of the seats and takes appropriate action based upon this information. For example, the central processor may record and/or transmit the number of passengers, seat belt usage, health of the passengers. The central processor may also determine whether safety restraint systems, such as airbags, associated with that vehicle seat, should be deployed in the event of a collision.

This application claims priority to U.S. Provisional Application Ser. No. 60/506,944, filed Sep. 29, 2003.

BACKGROUND OF THE INVENTION

This invention relates to vehicle passenger sensing. Vehicle passenger sensing is used for a variety of applications including, but not limited to monitoring passenger seat belt usage, controlling the deployment of safety restraint systems, monitoring the biometric signals of passengers for security, health care monitoring, and increased passenger service on commercial vehicles, and passenger counting on commercial vehicles. Vehicles that require intelligent passenger sensors include, but are not limited to, automobiles, aircraft, trains, boats, and amusement park rides.

### SUMMARY OF THE INVENTION

A vehicle passenger seat sensor network provides a plurality of vehicle seats, each having a plurality of occupant sensors associated therewith. The sensors could include passenger biometric heart-beat monitoring sensors, passenger presence sensors, and seat-belt usage sensors. A seat processor on each seat performs some analysis and processing of the data from the plurality of sensors and sends information based upon the data over a network to a central processor. The information could be the data, a filtered subset of the data and/or conclusions drawn from the data.

The central processor receives the information from each of the seats and takes appropriate action based upon this information. For example, the central processor may record and/or transmit the number of passengers, seat belt usage, health of the passengers. The central processor may also determine whether safety restraint systems, such as airbags, should be deployed in the event of a collision.

### BRIEF DESCRIPTION OF THE DRAWINGS

Other advantages of the present invention can be understood by reference to the following detailed description when considered in connection with the accompanying drawings wherein:

FIG. 1 illustrates the seat sensor network of the present invention installed in a vehicle.

FIG. 2 is a schematic view of the network of FIG. 1.

### DETAILED DESCRIPTION OF THE PREFERRED EMBODIMENTS

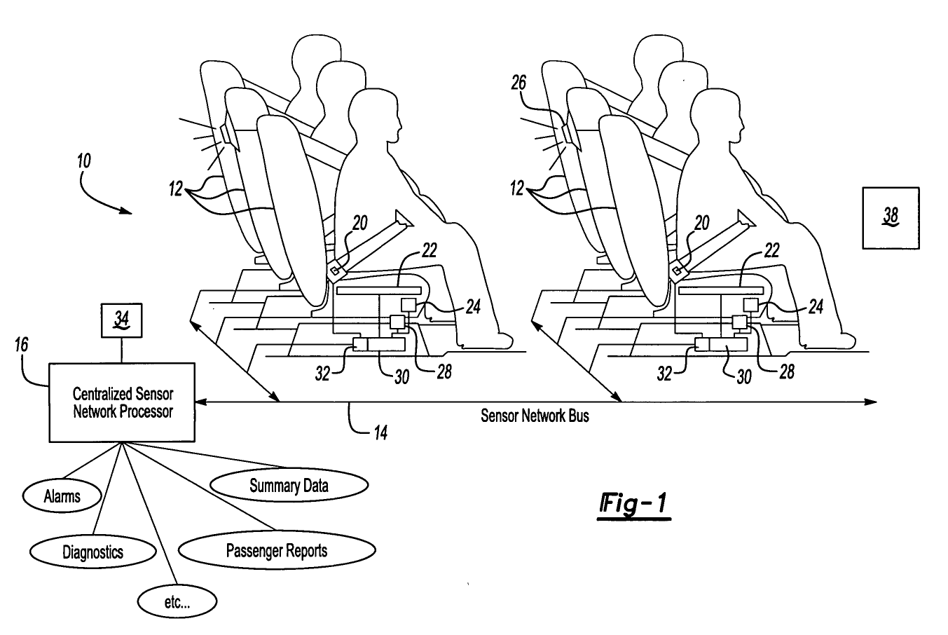

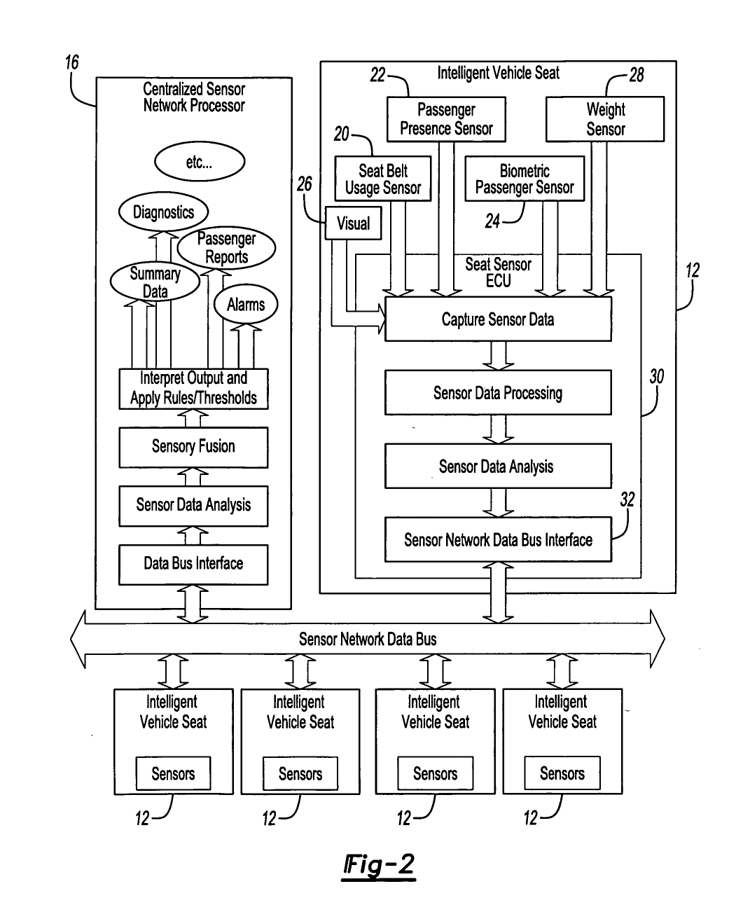

A seat sensor system 10 for vehicle passenger sensing is shown in FIG. 1 installed in a vehicle and is shown schematically in FIG. 2. As used herein, the term “vehicle” refers to any transportation mechanism including, but not limited to, automobiles, aircraft, spacecraft, sea-craft, trains, trucks, amusement park rides, utility vehicles, and agricultural equipment. The seat sensor system 10 includes three main components: the seat assemblies 12, the sensor network bus 14, and the centralized sensor network processor 16.

The seat assemblies 12 each include a plurality of sensors that are responsible for gathering passenger information and seat information using embedded sensor technology. Only five sensors 20, 22, 24, 26, 28 are illustrated in this example for simplicity, but many different sensors of different types could be utilized, as a greater or fewer number of sensors could also be utilized. In the preferred embodiment, these sensors can include, but are not limited to, seat-belt usage sensor 20, occupant presence sensor 22, biometric heartbeat monitoring sensors 24, visual (camera-based) passenger sensors 26 (which may be installed in the back of some of the seat assemblies 12) and passenger weight sensors 28. The presence sensor 22 could be a capacitance sensor. Additional sensors may be included to sense parameters such as amount of passenger movement, passenger position, passenger posture, seat position and the position of seat peripherals (such as fold-out trays).

Each seat assembly 12 further includes a processor or ECU 30 that collects data from all of the sensors 20, 22, 24, 26, 28 and performs basic processing and analysis. The ECU 30 generates information about the passenger and seat assembly 12 based upon the processing and analysis, such as passenger presence, weight, position, etc. Each seat assembly 12 further includes a network interface 32 for communicating information from the ECU 30 onto the sensor network bus 14. The seat sensor ECU 30 captures data from the seat sensors 20, 22, 24, 26, 28 and processes the data using hardware and software algorithms. The ECU 30 performs some basic analysis of the sensor data software algorithms to draw some conclusions and calculations based upon the data from the sensors. The processed sensor data, such as the conclusions and calculations, is packaged and sent to the central sensor network processor 16 using the sensor network data bus 14.

The sensor network bus 14 acts as a mechanism for communication information from the ECU 30, such as the sensor data, processed sensor data or analysis of the sensor data, to the centralized network processor 16. In the preferred embodiment, the sensor network bus 14 makes us of an existing vehicle data-bus for transit of this data. However, this invention may also make use of a separate, dedicated, data bus system, or even a wireless network.

The centralized sensor network processor 16 collects sensor data which has been broadcast on the sensor network data bus 14 by the seat assemblies 12. The centralized sensor network processor 16 is responsible for: i) collecting the sensor data, ii) processing and analyzing the data, iii) performing sensory fusion of multiple sources of sensor data, iv) interpreting the output, and v) generating usable outputs.

In operation, the ECU 30 performs all the processing required for basic sensing purposes. For example, it controls the seat-belt usage sensor 20, occupant presence sensor 22, biometric heartbeat monitoring sensor 24, the visual passenger sensor 26, and passenger weight sensor 28, and any other miscellaneous sensors, and determines their state. For instance, that ECU 30 could determine a heartbeat rate of 98, a presence signal of AFFIRMATIVE, in the NORMAL SEATING POSITION, and a seat belt indicator of NOT IN USE. That would all be reported back to the centralized sensor network processor 16 which would determine the meaning of the data (e.g. there is an aggravated or nervous person seated in seat 1B not wearing his seat belt) and produce the appropriate reports and alerts. The centralized sensor network processor 16 would also determine the total number of passengers based upon the presence indications from each of the ECUs 30 in the seat assemblies 12.

Outputs of the centralized sensor network processor 16 may include, but are not limited to, alarms, summary data, passenger reports, and diagnostic information. For example, the system 10 could be configured to automatically produce a report of all vehicle passengers who currently are in their seats, but not properly secured by the seat belt. The format of the processor output may include, but is not limited to, computer screen displays 34, printed reports, control of LED indicators, and audio signals.

The centralized sensor network processor 16 also determines whether safety restraints, such as an airbag 38 (one shown), should be activated in the event of a crash based upon the presence or absence of a passenger in the associated vehicle seat. The centralized sensor network processor 16 determines the force with which to deploy the airbag in the event of a crash based upon crash severity and based upon whether the passenger is wearing a seat belt, the weight of the passenger, position of the passenger, etc, based upon data from the sensors 20, 22, 24, 26, 28. After a crash, the centralized sensor network processor 16 can report the condition of the passenger based upon the heart rate as determined by the biometric heartbeat monitoring sensor 24. The seat assemblies 12 can be removed, moved, switched or replaced and automatically reconnect to the network and begin operation.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A seat sensor network comprising:
a first vehicle seat having a first plurality of sensors mounted thereon, the first plurality of sensors generating first sensor data;
a data bus for carrying the first sensor data; and
a processor for receiving the first sensor data over the data bus, the processor mounted off the first vehicle seat.

2. The seat sensor network of claim 1 wherein the first plurality of sensors includes at least one of: a biometric passenger sensor, a vision-based passenger sensor, a seat-belt usage sensor and a passenger presence detection sensor.

3. The seat sensor network of claim 1 further including a second vehicle seat having a second plurality of sensors mounted thereon, the second plurality of sensors generating second sensor data.

4. The seat sensor network of claim 3 wherein the processor receives the second sensor data over the data bus.

5. The seat sensor network of claim 4 wherein the processor is not mounted on the first vehicle seat or on the second vehicle seat.

6. The seat sensor network of claim 1 wherein the processor analyzes the first sensor data to determine the presence of an occupant in the first vehicle seat.

7. A method for collecting data from a plurality of seat sensors including the steps of:
collecting first data from a first sensor at a first vehicle seat;
sending the first data over a network; and
receiving the first data at a location remote from the first vehicle seat via the network.

8. The method of claim 7 further including the steps of:
collecting second data from a second sensor at a second vehicle seat;
sending the second data over the network; and
receiving the second data at the location, which is remote from the second vehicle seat, via the network.

9. The method of claim 8 further including the step of determining whether a vehicle safety system should be activated based upon the first data.

10. The method of claim 7 further including the step of determining whether a vehicle safety system should be activated based upon the first data.

11. A vehicle seat assembly including:
a vehicle seat having a seating surface;
at least one sensor gathering data regarding the seating surface;
a processor mounted on the vehicle seat, the processor capturing the data from the at least one sensor; and
a network interface sending information from the processor based upon the data.

12. The vehicle seat of claim 11 wherein the processor analyzes the data from the at least one sensor to determine the presence of an occupant on the seating surface.

13. The vehicle seat of claim 11 wherein the processor analyzes the data from the at least one sensor and generates the information based upon the analysis of the data.

14. The vehicle seat of claim 13 wherein the at least one sensor includes a plurality of sensors and wherein the processor generates the information based upon analysis of data from the plurality of sensors.

15. The vehicle seat of claim 11 wherein the processor analyzes the data from the at least one sensor to determine whether the at least one sensor is malfunctioning.
